(19) United States
(12) Patent Application Publication
(10) Pub. No.: US 2026/0008566 A1
(43) Pub. Date: Jan. 8, 2026

(54) DEVICE FOR CONTROLLING THE ANGULAR VELOCITY OF A SPACECRAFT, AND CORRESPONDING SPACECRAFT

(71) Applicants: AIRBUS DEFENCE AND SPACE SAS, Toulouse (FR); CENTRE NATIONAL D'ETUDES SPATIALES CNES, PARIS (FR)

(72) Inventors: Baptiste BRAULT, Toulouse (FR); Kristen LAGADEC, Toulouse (FR); Maxime SENES, Toulouse (FR)

(21) Appl. No.: 19/327,866

(22) Filed: Sep. 12, 2025

Related U.S. Application Data
(63) Continuation of application No. PCT/EP2023/087596, filed on Dec. 22, 2023.

(30) Foreign Application Priority Data
Mar. 13, 2023 (FR) 2302125

(51) Int. Cl. B64G 1/24; B64G 1/66; B64G 3/00; G01M 99/00

(52) U.S. Cl. CPC B64G 1/245; B64G 1/66; B64G 3/00; G01M 99/008

(57) ABSTRACT

A device (1) for controlling the angular velocity of an out-of-service spacecraft including: a stator (3) and a rotor (4) movable about an axis (A21) of rotation with respect to the stator. The stator (3) includes an electrically conductive and non-ferromagnetic body (6) while the rotor (4) includes a magnetized system (7) configured to induce, in the stator (3), eddy currents for braking a relative movement of the rotor (4) with respect to the stator (3); and a magnetic-suspension magnet (11) configured to cooperate with a magnetic field generated by an external source to suspend the rotor (4) magnetically with respect to the stator (3). The device (1) includes one or more non-ferromagnetic materials in a zone (11ZI) of influence of the magnetic field generated by the magnetic-suspension magnet.

### RELATED APPLICATION

This application is a by-pass continuation of international application PCT/EP2023/087596, filed Dec. 22, 2023, and claims priority to French patent application FR2302125, filed Mar. 13, 2023, both of which applications are incorporated by reference.

### TECHNICAL FIELD

The field of the invention is that of controlling the attitude of spacecraft, such as satellites. The invention relates more particularly to a device for controlling the angular velocity of an out-of-service spacecraft. Thus, the invention has applications, in particular, but not exclusively, for spacecraft for which an end-of-life removal operation must be envisaged.

### BACKGROUND

Out-of-service spacecraft contribute to the accumulation of space debris. The presence of such spatial debris in space is problematic because it constitutes pollution as the debris in question follows trajectories that may cross the orbit of functional spacecraft, which creates collision risks. Furthermore, collisions of debris with each other increase the total number of items of debris, which further accentuates the risk of collision for functional craft.

In this context, the regulations stipulate that an out-of-service satellite must not be left in orbit for more than 25 years. If such a satellite flies higher than about 600 km, the atmospheric drag is not sufficient to cause it to fall to Earth. Thus, either such a satellite is configured to descend by its own means or, if it breaks down before it can do so, another spacecraft will need to join it to cause it to descend to Earth.

However, even in the case of a satellite in sufficiently low orbit for the atmospheric drag to cause it to fall to Earth, it should be checked that no risk is associated with such a fall. For example, if the satellite contains too many parts likely to survive atmospheric re-entry (steel, titanium, ceramics), this could represent a risk on the ground if the satellite were to enter passively (i.e. anywhere). The satellite must then be capable of performing a so-called controlled re-entry requiring significantly more propellants and more delicate operations.

In addition, in order to capture and deorbit spatial debris such as a decommissioned satellite, spacecraft are known adapted to carry out maneuvers such as docking to the debris, so as to form a composite, such as for example deorbiting satellites such as those described in European patent applications EP2746163 and EP2671804. Nevertheless, it is understood that the rotational velocity of the out-of-service satellite remains a limiting factor for the success of the capture phase for such missions. Indeed, it is common for an out-of-service satellite to be driven with a high angular velocity, either due to a fatal failure that also interrupted the mission (propulsion failure, collision with debris), or due to the accumulation of low external disturbances (solar radiation pressure) over long periods of time. Furthermore, even in the case of a capture carried out successfully, the immediate follow-up of the operations for controlling the composite is incompatible with a high rotational velocity, in particular when the out-of-service satellite is connected to the deorbiting satellite by flexible links, such as for example a harpoon or a net.

European patent EP3538441 is also known which teaches a projectile comprising an external enclosure separated by a viscous fluid from a magnetized internal body.

In general, there is a need to improve the techniques for controlling an out-of-service spacecraft.

### SUMMARY

The invention relates to a device for controlling the angular velocity of an out-of-service spacecraft making it possible to facilitate the operations of active removal of the spacecraft as space debris. Such an angular velocity control device comprises a stator and a rotor movable about an axis of rotation with respect to the stator, the stator being intended to be driven by the spacecraft to be stabilized, the rotor being intended to be oriented according to the Earth's magnetic field. The stator comprises an electrically conductive and non-ferromagnetic body while the rotor comprises a magnetized system configured to induce, in the stator, eddy currents for braking a relative movement of the rotor with respect to the stator and to create a magnetic moment in the Earth's magnetic field. The rotor further comprises one (or more) magnetic-suspension magnets intended to cooperate with a magnetic field generated by a source external to the device in order to suspend the rotor magnetically with respect to the stator when the angular velocity control device is in the Earth's gravity. The angular velocity control device consists of one or more non-ferromagnetic materials at least in a zone of influence of the magnetic field generated by said magnetic-suspension magnet.

Thus, the invention proposes a novel and inventive solution for controlling the attitude of a decommissioned spacecraft (i.e. on board of which no energy source is available). This aim is achieved by a passive magnetic damping device attached to the structure of the platform, where a rotor equipped with magnets is free to rotate inside a non-ferromagnetic conductive stator (i.e. so as not to become magnetized over time). The magnets of the magnetized system are placed facing the body, for example made of aluminum. Even if the spacecraft pivots, the rotor remains aligned with the geomagnetic field: the differential angular velocity between the rotor and the platform creates eddy currents in the stator and thus dissipates the rotational kinetic energy, tending to stop the rotation of the spacecraft with respect to the Earth's magnetic field. Moreover, the implementation of one (or more) magnetic-suspension magnet(s) makes it possible to test the device for controlling the angular velocity on the ground, by simulating gravity via the cooperation of the magnet(s) in question with the magnetic field generated by an external source. Conversely, the angular velocity control device does not comprise any ferromagnetic material(s) at least in the area of influence of the magnetic field generated by the magnetic-suspension magnet(s). Thus, the presence of the magnetic-suspension magnet(s) 11 within the angular velocity control device does not disturb the rotation of the rotor with respect to the stator once the device is placed in orbit.

In some embodiments, the magnetized system comprises a plurality of braking magnets disposed in a plane perpendicular to the axis of rotation of the rotor.

In some embodiments, the magnetic moments of braking magnets add up according to a non-zero component in the plane perpendicular to the axis of rotation of the rotor so that the braking magnets also make it possible to orient the rotor according to the Earth's magnetic field.

Such a configuration makes it possible to combine the compass function and the current induction function.

In some embodiments, the magnetic moments of a plurality of the braking magnets are substantially perpendicular to the plane perpendicular to the axis of rotation of the rotor, so that the magnetic field thereof passes through the plane perpendicular to the axis of rotation of the rotor to induce eddy currents in at least two zones of the stator body located facing on either side of the plane perpendicular to the axis of rotation of the rotor. For example, the stator has a U-profile surrounding and on either side of the ring.

Thus, the amount of currents induced by a magnet of the rotor is doubled compared to an implementation wherein the magnetic moment of the magnet is substantially parallel to the rotational plane of the rotor (i.e. perpendicular to the axis of rotation of the rotor).

In some embodiments, the magnetic moments of a plurality of braking magnets form an oblique angle with respect to said plane perpendicular to the axis of rotation of the rotor.

Such a configuration makes it possible to combine the compass function and double the induced currents.

In some embodiments, the magnetic-suspension magnet(s) comprise a south pole and a north pole disposed along the axis of rotation.

Thus, the force generated in the presence of a magnetic field generated by a source external to the angular velocity control device is maximized in the direction of the axis of rotation.

In some embodiments, the rotor is guided into at least two housings of the stator centered along the axis of rotation, according to a mechanical contact of the counter-plane sphere type.

In some embodiments, the two housings each comprise a plain bearing closed, opposite the rotor, by a plane end stop partition disposed transversely to the bearing. Two spherical heads integrated into the rotor and centered along the axis of rotation are configured to cooperate with the two housings.

Thus, the rotor is adjusted to the stator with great precision (e.g. with a clearance of less than 1 mm) while minimizing the friction during the rotation of the rotor (e.g. the friction is preferably less than a fraction of the magnetic torque driving the rotor).

In some embodiments, the magnetic-suspension magnet(s) is/are permanently attached to the rotor.

In some embodiments, the magnetic-suspension magnet(s) is/are temporarily attached to the rotor.

Thus, the magnetic-suspension magnet(s) can be attached to the rotor only during the test phase on the ground. This makes the angular velocity control device lighter for orbiting.

In some embodiments, the magnetic-suspension magnet(s) is/are in an annular shape.

Thus, the force exerted by the magnetic-suspension magnet(s) in the presence of a magnetic field generated by a source external to the angular velocity control device is collinear to the axis of rotation. This makes it possible to minimize the horizontal gradient so as not to generate any lateral force (i.e. perpendicular to the axis of rotation during the test).

The invention also relates to a system comprising: an angular velocity control device as described above (according to any one of the aforementioned embodiments); and a device for testing the angular velocity control device. The test device comprises at least one magnetic field source intended to cooperate with the magnetic-suspension magnet(s) in order to suspend the rotor magnetically with respect to the stator in the Earth's gravity.

In some embodiments, the magnetic field source comprises a permanent magnet or an electromagnet.

The invention also relates to a method for testing on the ground an angular velocity control device as described above (according to any one of the aforementioned embodiments), by implementing a test device comprising one (or more) magnetic field source(s) intended to cooperate with the magnetic-suspension magnet(s) in order to suspend the rotor magnetically with respect to the stator in the Earth's gravity. Such a method comprises: a relative adjustment of the control device and of the test device, comprising a fine adjustment of the magnetic field generated by the magnetic field source(s) so that the magnetic field cooperates with the magnetic-suspension magnet(s) of the angular velocity control device in order to suspend the rotor magnetically with respect to the stator; and a functional test of the adjusted control device.

In some embodiments, the magnetic field source comprises an electromagnet. The method comprises at least one operation of the electromagnet to generate the magnetic field.

The invention also relates to a spacecraft comprising one or more angular velocity control devices as described previously (according to any one of the aforementioned embodiments).

In some embodiments, the spacecraft further comprises attitude control means along three axes adapted to stabilize the attitude of the spacecraft in activity. The angular velocity control device(s) of the craft when it is out of service act simultaneously with the attitude control means of the spacecraft in activity and exert a negligible action with respect to these attitude control means of the spacecraft in activity.

In some embodiments, each angular velocity control device is arranged so that the axis of rotation of the rotor forms an angle less than or equal to 45° with an axis of greater inertia of the spacecraft, such that the out-of-service spacecraft tends toward a rotational movement about this axis of greater inertia.

A first advantage of the invention is to make it possible to reduce the angular velocity of the satellite to be captured, prior to the capture thereof which is thus facilitated. The present invention thus makes it possible to prevent an out-of-service satellite from being animated with a significant angular velocity, either due to a fatal failure having caused the interruption of the mission such as a propulsion failure, or a collision with debris, or due to the accumulation of low external disturbances caused for example by solar radiation pressure, over long periods of time.

A second advantage of the invention is to make it possible to test the angular velocity control device on the ground, while simulating gravity via the cooperation of the magnetic-suspension magnet(s) with the magnetic field generated by an external source.

### SUMMARY OF FIGURES

Other aims, features and advantages of the invention will appear more clearly upon reading the following description, given by way of a simple illustrative and non-limiting example, in relation to the figures, wherein:

FIG. 1 shows a device for controlling the angular velocity of a spacecraft according to one example of embodiment of the invention;

FIG. 2 shows a device for controlling the angular velocity of a spacecraft according to another embodiment of the invention;

FIG. 3a shows a configuration of the braking magnets of a device for controlling the angular velocity of a spacecraft according to one example of embodiment of the invention;

FIG. 3b shows a configuration of the braking magnets of a device for controlling the angular velocity of a spacecraft according to another embodiment of the invention;

FIG. 4 shows a detailed view of an axial part of a device for controlling the angular velocity of a spacecraft as well as a device for testing the control device according to one embodiment of the invention;

FIG. 5 shows the steps of a method for testing on the ground a device for controlling the angular velocity of a spacecraft according to one example of embodiment of the invention;

FIG. 6 shows a simplified model of a device for controlling the angular velocity of a spacecraft making it possible to predict the derotation time constant of the spacecraft;

FIG. 7 shows a spacecraft equipped with two angular velocity control devices according to one embodiment of the invention.

### DETAILED DESCRIPTION

The general principle of the invention relies on a device for controlling the angular velocity of a spacecraft making it possible in particular to facilitate the operations of removing the spacecraft as space debris. Such a device comprises a stator and a rotor movable about an axis of rotation with respect to the stator, the stator being intended to be driven by the spacecraft to be stabilized, the rotor being intended to be oriented according to the Earth's magnetic field. The stator comprises an electrically conductive and non-ferromagnetic body while the rotor comprises a magnetized system configured to induce, in the stator, eddy currents for braking a relative movement of the rotor with respect to the stator and to create a magnetic moment in the Earth's magnetic field (compass function). The rotor behaves like a compass needle thanks to a magnetic torque bias provided by an asymmetric arrangement of the polarities of the braking magnets or thanks to dedicated orientation magnets.

Thus, even in the absence of an energy source on board the spacecraft, the rotor remains aligned with the Earth's magnetic field (compass function). The differential angular velocity between the rotor and the spacecraft creates eddy currents in the stator and thus dissipates the rotational kinetic energy, tending to stop the rotational movement of the spacecraft with respect to the Earth's magnetic field. The rotational velocity of the spacecraft is thus controlled.

Moreover, the rotor comprises one (or more) magnetic-suspension magnet(s) intended to cooperate with a magnetic field generated by a source external to the angular velocity control device in order to suspend the rotor magnetically with respect to the stator when the angular velocity control device is in the Earth's gravity. Moreover, the stator is made of a non-ferromagnetic material in a zone of influence of the magnetic field generated by the magnet(s). Thus, the angular velocity control device can be easily tested on the ground, the presence of the magnet (or magnets) making it possible to simulate gravity.

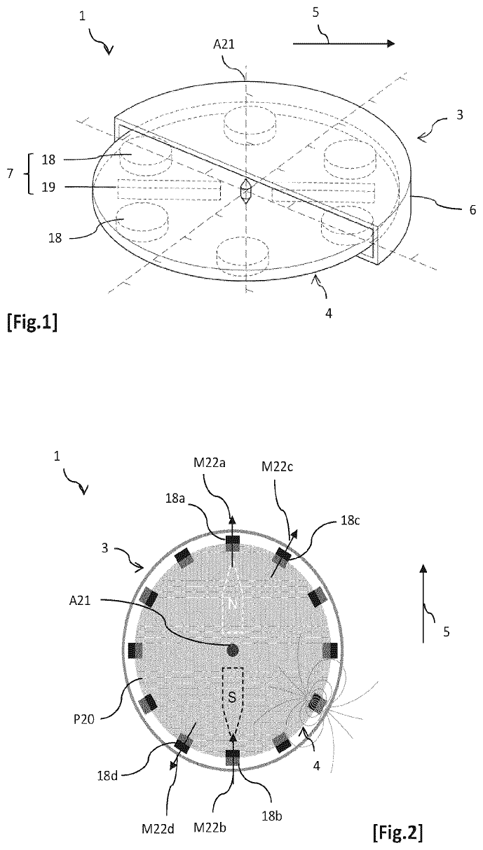

In relation to FIG. 1, a device 1 for controlling the angular velocity of a spacecraft 2 is now presented according to one example of embodiment of the invention.

As described further below in relation to FIG. 7, the device 1 according to the invention makes it possible in particular to control the angular velocity of the spacecraft 2 when the latter is out of service. This makes it possible, for example, to facilitate the operations of actively removing the spacecraft 2 as space debris.

Returning to FIG. 1, the device 1 comprises a stator 3 and a rotor 4 movable about an axis A21 of rotation of the rotor 4 with respect to the stator 3. For example, the stator is integral with the frame of the satellite. According to the application for controlling the angular velocity of the spacecraft 2, the stator 3 is intended to be driven by the spacecraft 2 to be stabilized. For its part, the rotor 4 is intended to orient according to the Earth's magnetic field 5.

Moreover, the stator 3 comprises an electrically conductive body 6, for example made of aluminum, while the rotor 4 comprises a magnetized system 7 configured to induce, in the stator 3, eddy currents for braking a relative movement of the rotor 4 with respect to the stator 3.

Thus, a passive magnetic damping device is obtained intended to be attached to the structure of the spacecraft 2, where the rotor 4 equipped with the magnetized system 7 is free to rotate inside a stator 3.

The body 6 of the stator 3 is electrically conductive and non-ferromagnetic so as not to become magnetized over time. The body 6 is for example made of aluminum or copper.

Moreover, according to the example of embodiment of FIG. 1, the magnetized system 7 comprises, on the one hand, braking magnets 18 and, on the other hand, orientation magnets 19. The braking magnets 18 are configured to induce, in the stator 3, the eddy currents for braking the relative movement of the rotor 4 with respect to the stator 3. The orientation magnets 19 are configured to create a magnetic moment in the Earth's magnetic field 5. This makes it possible to maintain the orientation of the rotor 4 with respect to the Earth's magnetic field 5 (compass function).

In relation to FIG. 2, an angular velocity control device 1 is now presented, according to another embodiment of the invention.

According to the example of embodiment of FIG. 2, the magnetized system 7 comprises a plurality of braking magnets 18a, 18b, 18c, 18d disposed according to a plane P20 perpendicular to the axis A21 of rotation of the rotor 4 with respect to the stator 3.

More particularly, the magnetic moments M22a and M22b of the braking magnets 18a and 18b add up according to a non-zero component in the plane P20 so that the braking magnets 18a and 18b also make it possible to orient the rotor 4 according to the Earth's magnetic field 5.

Thus, in this example of embodiment, the braking magnets 18 fulfill the function of the orientation magnets 19 (compass function). The braking magnets 18 and the orientation magnets 19 are here the same magnets.

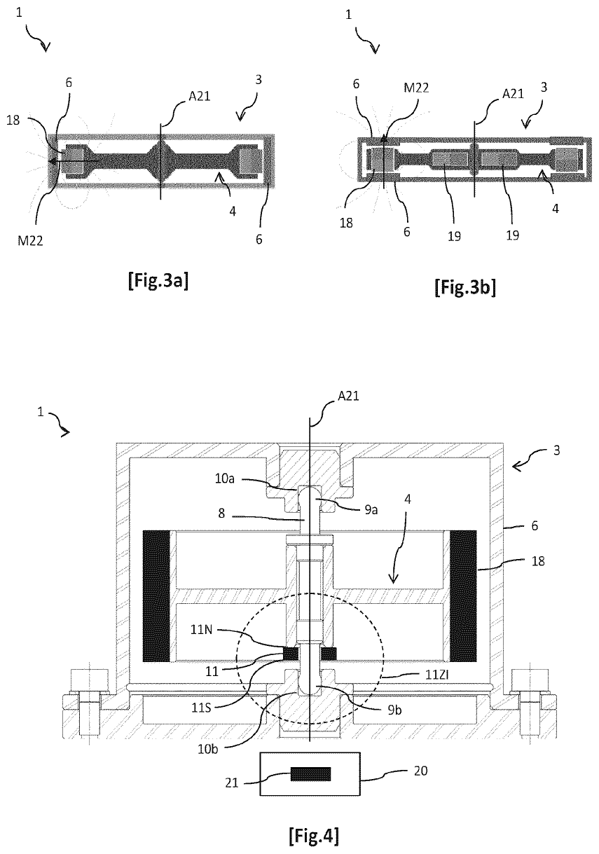

In relation to FIG. 3a, a configuration of the braking magnets 18 is now presented according to one example of embodiment of the invention.

More particularly, the magnetic moments M22 of a plurality of braking magnets 18 are here substantially parallel to the plane P20 perpendicular to the axis A21 of rotation of the rotor 4.

In such a radial configuration, the radius of the trajectory of the induced eddy currents is maximized in the body 6. This also maximizes energy dissipation.

Moreover, the same braking magnets 18 can also be used to ensure the function of orienting the rotor 4 with respect to the stator 3 as described above in relation to FIG. 2.

According to such a configuration of the braking magnets 18, it is also easier to control the size of the air gap between the magnets 18 and the body 6 of the stator 3 (e.g. to address the problem of launch vibrations, free play in the pivot of the rotor 4) or to house magnets 18 with a larger aspect ratio (e.g. a larger height of the magnets 18 makes a larger air gap possible).

Moreover, the housing of the stator 3 may be made of any material, for example plastic, with simply a track 6 made of non-ferromagnetic material (e.g. made of aluminum or copper) forming a housing or disposed in a housing made in the stator 3, facing the magnets 18. This housing extends for example around the stator with a U-profile. The stator comprises, for example, a cylindrical ring coming into this housing.

In relation to FIG. 3b, a configuration of the braking magnets 18 is now presented according to another embodiment of the invention.

More particularly, the magnetic moments M22 of a plurality of braking magnets 18 are here substantially perpendicular to the plane P20. In other words, the magnetic moments M22 of the braking magnets 18 in question are here substantially parallel to the axis A21 of rotation of the rotor 4.

Thus, the magnetic field of the braking magnets 18 passes through the plane P20 to induce eddy currents in at least two zones of the body 6 of the stator 3 located facing on either side of the plane P20 in question. The eddy currents thus induced are potentially doubled with respect to a radial configuration of the braking magnets 18 as described above in relation to FIG. 3a. However, in the normal configuration of the braking magnets 18 of FIG. 3b, the braking magnets 18 cannot fulfill at the same time the function of orienting the rotor 4 with respect to the stator 3. Additional magnets fulfilling the function of orienting the rotor 4 with respect to the stator 3 are here necessary, for example orienting magnets 19 as described above in relation to FIG. 1.

In other implementations, the additional magnets fulfilling the function of orienting the rotor 4 with respect to the stator 3 are other braking magnets 18 in radial configuration as described above in relation to FIG. 3a. Thus, a mixed configuration is obtained with some braking magnets 18 in normal configuration and some braking magnets 18 in radial configuration.

In other implementations, the magnetic moments M22 of a plurality of braking magnets 18 form an oblique angle with respect to the plane P20 perpendicular to the axis A21 of rotation of the rotor 4. For example, the magnetic moments M22 in question form an angle with the axis A21 of rotation of the rotor 4 between 10 degrees and 80 degrees, preferably between 30 degrees and 60 degrees. In such a configuration, eddy currents are also induced on either side of the plane P20 in question. Moreover, a non-zero component of the total magnetic moment of the braking magnets 18 can thus be obtained in the plane P20 in question. In this way, the braking magnets 18 also ensure the function of orienting the rotor 4 with respect to the stator 3 (compass function).

In relation to FIG. 4, the axial part of the angular velocity control device 1 as well as a device 20 for testing the angular velocity control device 1 are now presented according to one example of embodiment of the invention.

In practice, the rotor 4 must be adjusted to the stator 3 with sufficient precision so that the braking magnets 18 typically move less than 1 mm from the body 6 of the stator 3 without ever touching each other. Moreover, the means for adjusting the rotor 4 to the stator 3 must induce as little friction as possible, so that the rotor 4 is always free to rotate. The friction must preferably be less than a fraction of the magnetic torque driving the rotor 4. For this purpose, the rotor 4 is here guided in two housings 10a, 10b corresponding to the stator 3 according to a mechanical contact of the counter-plane sphere type. To do this, the two housings 10a, 10b each comprise for example a plain bearing closed, opposite the rotor 4, by a flat end stop partition disposed transversely to the bearing. Two spherical heads 9a, 9b integrated into the rotor 4 and centered along the axis of rotation A21 are configured to cooperate with the two housings 10a, 10b. According to such a pivot technology, the resistive torque obtained during the rotation of the rotor 4 with respect to the stator 3 is very low, in particular in orbital condition (i.e. in the absence of perceived gravity).

However, in order to perform the tests on the ground, additional means are implemented in order to recreate the operational conditions of the angular velocity control device 1 in orbit.

More particularly, the angular velocity control device 1 comprises one (or more) magnetic-suspension magnets 11. The magnetic-suspension magnet(s) 11 is/are intended to cooperate with a magnetic field generated by a source external to the angular velocity control device 1 in order to suspend the rotor 4 magnetically with respect to the stator 3 when the angular velocity control device 1 is in the Earth's gravity.

More particularly, the source external to the angular velocity control device 1 is here provided by the test device 20. Indeed, such a test device 20 comprises one (or more) magnetic field sources 21 intended to cooperate with the magnetic-suspension magnet(s) 11 in order to suspend the rotor magnetically 4 with respect to the stator 3 in the Earth's gravity. For example, the magnetic field source(s) 21 comprises a permanent magnet or an electromagnet.

However, so that the presence of the magnetic-suspension magnet(s) 11 within the angular velocity control device 1 does not disturb the pivot technology described above in orbit, the angular velocity control device 1 consists of one or more non-ferromagnetic materials at least in a zone 11ZI of influence of the magnetic field generated by the magnetic-suspension magnet(s). Thus, the magnetic-suspension magnet(s) 11 does/do not exert any additional force on the rotor 4 when the angular velocity control device 1 is isolated from the test device 20, e.g. when the angular velocity control device 1 is in orbit.

According to the present example of embodiment, the magnetic-suspension magnet(s) 11 comprise(s) a south pole 11S and a north pole 11N disposed along the axis A21 of rotation (e.g. the magnetic moment of the magnetic-suspension magnet(s) 11 is parallel to the axis A21 of rotation). In this way, the force generated in the presence of a magnetic field generated by a source external to the angular velocity control device 1 is maximized in the direction of the axis A21 of rotation. However, other provisions may be considered.

According to some implementations, the magnetic-suspension magnet(s) 11 is/are permanently attached to the rotor 4.

However, according to other implementations, the magnetic-suspension magnet(s) 11 is/are temporarily attached to the rotor 4. Thus, the magnetic-suspension magnet(s) 11 can be removed from the angular velocity control device 1 after the test phase on the ground. The angular velocity control device 1 is thus lighter for orbiting.

The remanence of the magnetic-suspension magnet(s) 11 is chosen according to the volume thereof (e.g. the remanence of the magnetic-suspension magnet(s) 11 of the angular velocity control device 1 is taken equal to 1 Tesla). The volume is determined in particular as a function of the weight of the rotor 4 and as a function of the magnetic field source 21. For example, it is preferable to minimize the horizontal gradient so as not to generate a lateral force (i.e. perpendicular to the axis A21 of rotation during the test).

Thus, according to some implementations, the magnetic-suspension magnet(s) 11 is/are in an annular shape. For example, the magnetic-suspension magnet(s) 11 has/have an annular shape of rotation about the axis A21 of rotation. In this way, the force exerted by the magnetic-suspension magnet(s) 11 in the presence of the magnetic field of the source 21 is collinear to the axis A21 of rotation. This makes it possible, for example, to avoid biasing the test on the ground of the angular velocity control device 1 by adding a lateral force on the rotor with respect to the axis A21 of rotation.

Similarly, the smaller the magnetic field source 21, the greater the horizontal gradient will be. Conversely, the larger the magnetic field source 21, the more uniform the field. In particular, a coil-type electromagnet makes it possible to simply create a relatively uniform magnetic field.

For example, the choice of the features of the (or of the) magnetic-suspension magnet(s) 11 of the angular velocity control device 1 as well as the features of the magnetic field source 21 results from an iterative and empirical process. For example, the more the magnetic field source 21 is physically extended, the finer the adjustment thereof must be.

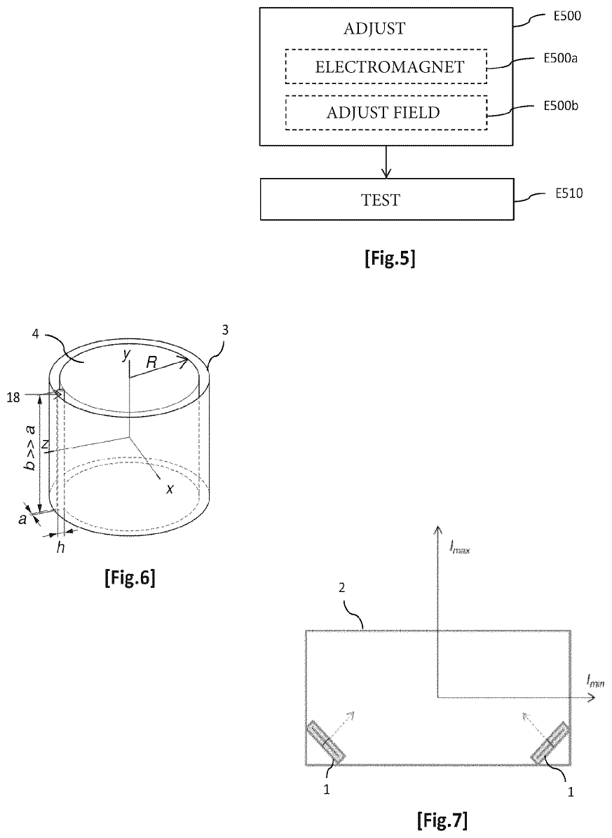

In relation to FIG. 5, the steps of a method for testing on the ground the angular velocity control device 1 are now presented according to one embodiment of the invention.

More particularly, such a test method implements a test device 20 as described above (according to any one of the embodiments described above).

Thus, during an adjustment step E500, the angular velocity control device 1 is adjusted relative to the test device. The adjustment step E500 comprises a step E500b of fine adjustment of the magnetic field generated by the magnetic field source 21 so that the magnetic field cooperates with the magnet(s) 11 for suspending the angular velocity control device 1 in order to suspend the rotor 4 magnetically with respect to the stator 3.

Such a fine adjustment comprises, for example, the relative positioning of the devices so that the magnetic field generated by the source 21 of the test device 20 cooperates with the magnet(s) 11 for suspending the angular velocity control device 1 in order to suspend the rotor 4 magnetically with respect to the stator 3. This is for example the case when the source 21 comprises a permanent magnet. In such a case, the relative positioning of the devices makes it possible to optimize the value of the magnetic field generated by the source 21 of the test device 20 as felt by the magnetic-suspension magnet(s) 11 of the angular velocity control device 1. Alternatively, when the magnetic field source 21 comprises an electromagnet, step E500 comprises, for example, a step E500a of operating the electromagnet to generate the magnetic field, then, if applicable, implementing step E500b of fine adjustment of the magnetic field generated by the magnetic field source 21 (e.g. via adjusting the current injected into the electromagnet) so as to obtain the desired magnetic bearing effect of the rotor 4 with respect to the stator 3.

During a test step E510, the functional test of the angular velocity control device 1. Due to the magnetic suspension of the rotor 4 with respect to the stator 3, such a functional test, although performed on the ground, makes it possible to test the functionality of the angular velocity control device 1 under conditions simulating gravity.

In relation to FIG. 6, a simplified model of the angular velocity control device 1 is now presented according to one embodiment of the invention.

More particularly, such a model makes it possible to estimate the derotation time constant of a spacecraft to which an angular velocity control device according to the present technique would be attached.

As a simplifying hypothesis, a braking magnet 18 is considered here with a length b sufficiently large with respect to the width a thereof that may be considered as infinite. The braking magnet 18 is housed radially at the periphery of a cylindrical rotor 4 of infinite length along the axis (y-axis) and radius R thereof. The braking magnet 18 moves at an assumed infinitesimal distance ε (=air gap) from a cylindrical metal housing, also of infinite length along the axis of the cylinder, modeling the stator 3.

The magnet 18 is magnetized radially and the height h thereof along the radial direction is large enough with respect to the width thereof so that it can also be considered as infinite. Due to the infinite height of the magnet 18, the magnetic field B generated by the magnet 18 at the surface thereof approaches the asymptotic value, characterized by the remanence, Br, of the material:

$$B = \frac{{B}_{r}}{2} \qquad [ Math . 1 ]$$

According to such a one-dimensional model, the electric field and currents have non-zero components only along the y-axis. This simplifies the analysis, because Maxwell-Faraday's law:

$$∇ \times E = - \frac{\partial B}{\partial t} \qquad [ Math . 2 ]$$

is reduced to a single differential equation:

$$\frac{\partial {E}_{y}}{\partial x} = - \frac{\partial {B}_{z}}{\partial t} = - \frac{\partial {B}_{z}}{\partial x} R ω \qquad [ Math . 3 ]$$

where R is the radius of the cylinder and ω the angular velocity of rotation of the cylinder about the axis thereof. As the electric field and magnetic field are infinitely zero, the integration according to x of the equation [Math. 3] is simple. As a result, the axial electric field is proportional to the radial magnetic field according to the following relationship:

$${E}_{y} = - B \cdot R ω = - \frac{{B}_{r}}{2} \cdot R ω \qquad [ Math . 4 ]$$

The electrical power P dissipated per unit of volume V of the housing of the stator 3 (considering a resistivity material p) for a single magnet 18 is then:

$$\frac{dP}{dV} = \frac{1}{ρ} \cdot {E}_{y}^{2} = \frac{{B}_{r}^{2}}{4 ρ} \cdot {R}^{2} {ω}^{2} \qquad [ Math . 5 ]$$

In order to obtain the total dissipated electrical power P, the preceding relationship must be integrated on the volume where the phenomenon occurs, assumed to be e×a×b (where e is the thickness of the stator housing 3, a is the width of the magnet in the tangential direction, b is the actual and finite length of the magnet along y). Thus, the following is obtained:

$$P = \frac{{B}_{r}^{2}}{4 ρ} \cdot eab \cdot {R}^{2} {ω}^{2} \qquad [ Math . 6 ]$$

When considering a rotor 4 with n braking magnets 18, the total power dissipated is assumed to be proportional to n (assuming that the magnets 18 do not interact with each other). When the stator 3 is driven by the spacecraft 2 to be stabilized and the rotor remains oriented according to the Earth's magnetic field, the total dissipated electrical power P actually corresponds to a loss of kinetic energy of the satellite Ė=Iω\dot{ω}, with/the inertia of the spacecraft 2 to be stabilized around the axis of the cylinder. Thus, the following is obtained:

$$nP = I ω \dot{ω} = \frac{{B}_{r}^{2}}{4 ρ} \cdot neab \cdot {R}^{2} {ω}^{2} \qquad [ Math . 7 ]$$

A time constant τ for the exponential decrease of the angular velocity can be deduced from the previous relationship:

$$τ = \frac{ω}{\dot{ω}} = \frac{4 ρ I}{{B}_{r}^{2} {R}^{2} \cdot neab} \qquad [ Math . 8 ]$$

By way of example, a time constant of t of 28 days is obtained for the following values of the parameters of the equation [Math. 8]:

Number of magnets 18, no.: 8;
width of a magnet 18 in the tangential direction, a: 3 mm;
actual length of the magnet along y, b: 15 mm;
thickness of the stator housing 3, e: 1 mm;
resistivity of the material, ρ: 2.7×10⁻⁸ Ω·m;
radius of the rotor 4, R: 2.5 cm;
remanence of a magnet, Br: 1 T; and
inertia of the spacecraft 2 to be stabilized around the axis of the cylinder, I: 5,000 kg·m².

In relation to FIG. 7, a spacecraft 2 is now presented equipped with two angular velocity control devices 1 according to one example of embodiment of the invention.

More particularly, the stator 3 of each device 1 is attached to the spacecraft 2 so as to be driven by the spacecraft 2. The rotor 4 of each device 1 orients according to the Earth's magnetic field 5.

According to the present embodiment, two angular velocity control devices 1 are implemented in the spacecraft 2 to be stabilized when it is out of service. Indeed, an angular velocity control device 1 according to the present technique cannot theoretically damp angular velocities normal to the axis thereof. However, an out-of-service spacecraft 2 will naturally tend to follow a rotational movement around the main axis of maximum inertia thereof. Thus, if such an angular velocity control device 1 is not implanted so as to have the axis A21 of rotation thereof strictly perpendicular to the main axis of maximum inertia, residual angular rotation rates can be expected to be observed.

Thus, if a single angular velocity control device 1 is theoretically sufficient to dampen the rotation of the spacecraft 2 around the 3 axes of inertia, it may be interesting in practice to implement two or three angular velocity control devices 1 for redundancy purposes.

However, in other embodiments, the spacecraft 2 is equipped with a single angular velocity control device 1.

In some embodiments, the axis A21 of rotation of the rotor 4 of the angular velocity control device(s) 1 forms an angle less than or equal to 45° with the axis of greater inertia of the spacecraft 2 (axis denoted “Iₘₐₓ” in FIG. 7]), such that the out-of-service spacecraft 2 tends toward a rotational movement about this axis of greater inertia. Indeed, the rotation of the spacecraft 2 will naturally tend towards a rotation around the axis of greater inertia (the so-called “flat spin” phenomenon) thereof. Thus, an arrangement according to which the axis or axes A21 of rotation of the rotor(s) 4 of the angular velocity control device(s) 1 form an angle less than or equal to 45° with the axis of greater inertia of the spacecraft 2 makes it possible to guarantee dissipation of the kinetic energy of rotation of the spacecraft 2 about the axis thereof of greater inertia having as a consequence to brake the rotation of the spacecraft.

The spacecraft 2 in activity further comprises attitude control means according to three axes adapted to stabilize the attitude of the spacecraft in activity. The angular velocity control device(s) 1 act(s) simultaneously with the attitude control means of the spacecraft in activity but exert a negligible action with respect to these means for controlling the attitude of the spacecraft in activity.

In this way, the angular velocity control device(s) 1 has/have a negligible effect on the attitude control of the spacecraft 2 when the latter is in activity, but make it possible to control the angular velocity of the spacecraft 2 when the latter is out of service.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both, unless the disclosure states otherwise. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A device for controlling an angular velocity of an out-of-service spacecraft to facilitate operation of active removal of the spacecraft as space debris, the device comprising:
a stator and a rotor movable about an axis of rotation with respect to the stator, the stator is configured to be driven by the spacecraft to be stabilized, and the rotor is configured to orient according to the Earth's magnetic field,
wherein the stator comprises an electrically conductive and non-ferromagnetic body and the rotor comprises a magnetic braking system configured to induce, in the stator, eddy currents for braking a relative movement of the rotor with respect to the stator and to create a magnetic moment in the Earth's magnetic field,
wherein the rotor further comprises at least one magnetic-suspension magnet configured to cooperate with a magnetic field generated by a source external to said device in order to suspend the rotor magnetically with respect to the stator when the angular velocity control device is in the Earth's gravity, and
wherein the angular velocity control device consists of one or more non-ferromagnetic materials at least in a zone of influence of the magnetic field generated by said magnetic-suspension magnet.

2. The device according to claim 1, wherein said magnetic-suspension magnet comprises a south pole and a north pole disposed along the axis of rotation.

3. The device according to claim 1, wherein the rotor is guided in at least two housings of the stator centered along the axis of rotation, according to a mechanical contact of a counter-plane sphere type.

4. The device according to claim 3, wherein said two housings each comprise a plain bearing closed, opposite the rotor, by a plane end stop partition disposed transversely to the bearing, two spherical heads integrated into the rotor and centered along the axis of rotation being configured to cooperate with said two housings.

5. The device according to claim 1, wherein said magnetic-suspension magnet is permanently attached to the rotor.

6. The device according to claim 1, wherein said magnetic-suspension magnet is temporarily attached to the rotor.

7. The device according to claim 1, wherein the magnetic-suspension magnet is in an annular shape.

8. A system comprising:
the device according to claim 1, and
a test device configured to test said device,
wherein the test device comprises at least one magnetic field source configured to cooperate with said magnetic-suspension magnet in order to suspend the rotor magnetically with respect to the stator in the Earth's gravity.

9. The system according to claim 8, wherein said magnetic field source comprises a permanent magnet or an electromagnet.

10. A method for testing on the ground the device according to claim 1, including:
implementing a test device comprising at least one magnetic field source configured to cooperate with said magnetic-suspension magnet to suspend the rotor magnetically with respect to the stator in the Earth's gravity, and
making a relative adjustment of the device and of the test device, wherein the relative adjustment comprises a fine adjustment of the magnetic field generated by said magnetic field source so that said magnetic field cooperates with said magnetic-suspension magnet of the device in order to suspend said rotor magnetically with respect to the stator; and
performing a functional test of the device after the making of the relative adjustment of the device.

11. The method according to claim 10, wherein said magnetic field source comprises an electromagnet, the method comprising at least one operation of the electromagnet to generate said magnetic field.

12. A spacecraft comprising the device according to claim 1.

13. The spacecraft according to claim 12, further comprising a three axis attitude control device adapted to stabilize the attitude of the spacecraft in activity,
wherein said device is acting simultaneously with an attitude control device of the spacecraft in activity and exercising a negligible action with respect to the attitude control device of the spacecraft in activity.

14. The spacecraft according to claim 12, wherein said angular velocity control device is arranged so that an axis of rotation of the rotor forms an angle less than or equal to 45° with an axis of greater inertia of the spacecraft, such that the spacecraft tends toward a rotational movement about this axis of greater inertia.
